(19) United States
(12) Patent Application Publication
(10) Pub. No.: US 2011/0200367 A1
(43) Pub. Date: Aug. 18, 2011

(54) IMAGE FORMING APPARATUS

(75) Inventor: Shoko Shimmura, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/026,457

(22) Filed: Feb. 14, 2011

Related U.S. Application Data
(60) Provisional application No. 61/305,376, filed on Feb. 17, 2010.

(51) Int. Cl. G03G 15/16

(52) U.S. Cl. 399/307; 399/308

(57) ABSTRACT

According to one embodiment, a developing unit forms a visible image on the image carrying member by supplying a developer to the image carrying member. A first transferring unit transfers the visible image on the image carrying member to the primary transferring member. A secondary transferring member is in contact with the primary transferring member. A second transferring unit transfers the visible image transferred to the primary transferring member to the secondary transferring member by applying a pressure from 10 to 100 gf/cm² and an electric field to a contact portion between the primary transferring member and the secondary transferring member. A transferring and fixing unit transfers and fixes the visible image transferred to the secondary transferring member to a recording medium.

### CROSS-REFERENCE TO RELATED APPLICATIONS

This application is based upon and claims the benefit of priority from U.S. provisional applications 61/305,376, filed on Feb. 17, 2010, the entire contents of which are incorporated herein by reference.

### FIELD

Embodiments described herein relate generally to an image forming apparatus.

### BACKGROUND

In an image forming apparatus of a simultaneous transferring and fixing process for performing transferring and fixing simultaneously, a developer image formed on an image carrying member is transferred to a primary transferring member, the developer image transferred to this primary transferring member is transferred to a secondary transferring member, and the developer image transferred to this secondary transferring member is transferred and fixed to a recording medium by heating and pressing.

In such an image forming apparatus, heat of the secondary transferring member is transferred to the image carrying member and the developer image on the image carrying member through the primary transferring member, and sometimes adversely affects the image formation.

### BRIEF DESCRIPTION OF THE DRAWINGS

FIG. 1 is a view showing a structure of main parts according to an embodiment.

FIG. 2 is a cross-sectional view showing a structure of a primary transferring belt according to an embodiment.

FIG. 3 is a cross-sectional view showing a structure of a modification example of a primary transferring belt according to an embodiment.

### DETAILED DESCRIPTION

In general, according to one embodiment, an image forming apparatus includes:

an image carrying member;

a developing unit which forms a developer image on the image carrying member by supplying a developer to the image carrying member;

a primary transferring member which is in contact with the image carrying member;

a first transferring unit which transfers the developer image formed on the image carrying member to the primary transferring member by applying an electric field to the image carrying member and the primary transferring member;

a secondary transferring member which is in contact with the primary transferring member;

a second transferring unit which transfers the visible image transferred to the primary transferring member to the secondary transferring member by applying a pressure from 10 to 100 gf/cm² and an electric field to a contact portion between the primary transferring member and the secondary transferring member; and

a transferring and fixing unit which transfers and fixes the developer image transferred to the secondary transferring member to a recording medium by heating and pressing.

Hereinafter, an embodiment will be described with reference to the drawings.

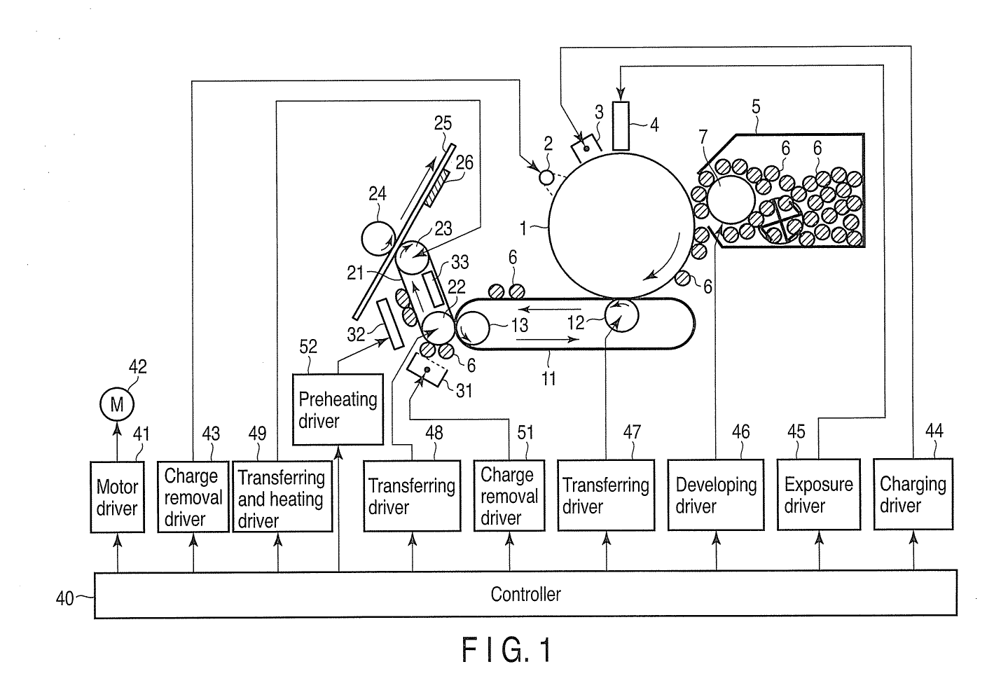

As shown in FIG. 1, around a photoconductive drum 1 which is a rotating image carrying member, a charge removal unit 2, a charging unit 3, an exposure unit 4, and a developing unit 5 are arranged in this order.

The charge removal unit 2 removes the charge remaining on the surface of the photoconductive drum 1 by irradiating the photoconductive drum 1 with light from a lamp or a light emitting diode (charge removal).

The charging unit 3 gives an electrostatic charge to the surface of the photoconductive drum 1 by applying a high voltage to the photoconductive drum 1. The exposure unit 4 exposes the surface of the charged photoconductive drum 1 to a laser beam or a LED luminescence to form an electrostatic latent image on the surface of the photoconductive drum 1.

The developing unit 5 contains a developer, a so-called toner (colored particles) 6, composed of a thermoplastic binder resin, a coloring material, and the like, and has a developing roller 7. This developing roller 7 charges the toner 6 by applying a charge thereto and supplies the charged toner 6 to the surface of the photoconductive drum 1 exposed to light by the exposure unit 4. By supplying this toner 6, the electrostatic latent image formed on the surface of the photoconductive drum 1 is developed to form a visible image (also referred to as a developer image or a toner image). This visible image is formed by the toner 6.

A primary transferring belt 11 which is a primary transferring member is rotatably disposed in an endless form in contact with the surface of the photoconductive drum 1. A first transferring roller 12 which is a first transferring unit is disposed in contact with the back surface of the primary transferring belt 11 at a position facing the photoconductive drum 1 sandwiching this primary transferring belt 11 therebetween. This first transferring roller 12 transfers the visible image formed on the photoconductive drum 1 to the primary transferring belt 11 by applying an electric field to a contact portion (also referred to as a nip portion) between the photoconductive drum 1 and the primary transferring belt 11 while rotating along with the motion of the primary transferring belt 11.

A backup roller 13 which rotates in contact with the back surface of the primary transferring belt 11 is disposed. A secondary transferring belt 21 which is a secondary transferring member is rotatably disposed in an endless form in contact with the back surface of the primary transferring belt 11 at a position facing the backup roller 13 sandwiching the primary transferring belt 11 therebetween. A second transferring roller 22 which is a second transferring unit is disposed in contact with the back surface of the secondary transferring belt 21 at a position facing the backup roller 13 sandwiching the primary transferring belt 11 and the secondary transferring belt 21 therebetween.

This second transferring roller 22 transfers the visible image transferred to the primary transferring belt 11 to the secondary transferring belt 21 by applying an electric field to a contact portion (also referred to as a nip portion) between the primary transferring belt 11 and the secondary transferring belt 21.

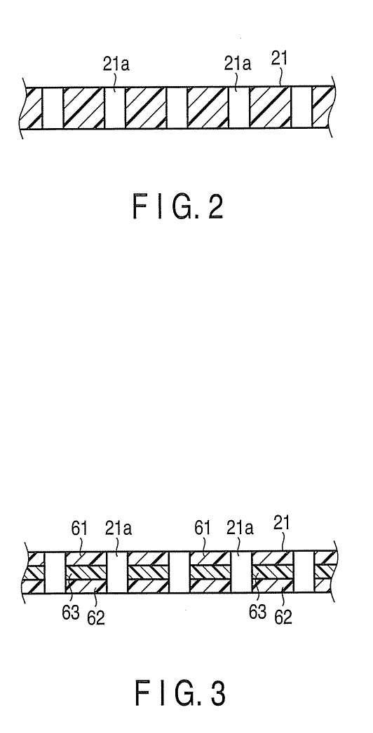

As shown in FIG. 2, the secondary transferring belt 21 is formed of a porous elastic member having a lot of pores 21a. As the porous elastic member, for example, porous polyimide in which carbon black is incorporated by kneading is used. The opening of each pore 21a has a diameter of, for example, 0.2 μm. The proportion of the total area of the openings of the pores 21a is, for example, 30% of the surface area of the secondary transferring belt 21.

The secondary transferring belt 21 formed of such a porous elastic member has a lower electrical resistivity as compared with a transferring belt formed of an elastic member having no pores. That is, the electrical resistivity of the surface of the secondary transferring belt 21 is, for example, 10⁺¹⁰ Ωcm. The electrical resistivity of the primary transferring belt 11 in the thickness direction is, for example, 10⁺⁹ Ωcm. These electrical resistivities can be adjusted by the content of the above-mentioned carbon black. When the content of carbon black is increased, the electrical resistivity is decreased, and when the content of carbon black is decreased, the electrical resistivity is increased.

The primary transferring belt 11 may be formed of either a porous elastic member in the same manner as the secondary transferring belt 21 or an elastic member having no pores.

A transferring and fixing roller 23 which rotates in contact with the back surface of the secondary transferring belt 21 is disposed. A pressing roller 24 is disposed in contact with the surface of the secondary transferring belt 21 at a position facing this transferring and fixing roller 23 sandwiching the secondary transferring belt 21 therebetween. A recording medium, for example, a recording sheet 25 is conveyed to a contact portion (also referred to as a nip portion) between the pressing roller 24 and the secondary transferring belt 21.

The transferring and fixing roller 23 transfers and fixes the visible image transferred to the secondary transferring belt 11 to the recording sheet 25 by heating and pressing. By this transferring and fixing, an image 26 is formed on the recording sheet 25. The amount of heating by the transferring and fixing roller 23 may be an amount needed for transferring and fixing the visible image.

A second charge removal unit 31 is disposed at a position facing the surface of the secondary transferring belt 21 on the downstream side of the contact portion with the primary transferring belt 11 in the rotating direction of the secondary transferring belt 21. This second charge removal unit 31 reduces the charge amount of the toner 6 in the visible image transferred to the secondary transferring belt 21 using, for example, a scorotron charger at a stage before the transferring and fixing roller 23 performs transferring and fixing.

As a preheating member, for example, an infrared radiation plate 32 is disposed at a position facing the surface of the secondary transferring belt 21 on the downstream side of the second charge removal unit 31 in the rotating direction of the secondary transferring belt 21. This infrared radiation plate 32 preheats the visible image whose charge amount was reduced by the second charge removal unit 31 to about 40 to 100° C. by radiating infrared light to the secondary transferring belt 21 at a stage before the transferring and fixing roller 23 performs transferring and fixing.

Incidentally, this infrared radiation plate 32 is most preferably disposed in parallel to the secondary transferring belt 21 at a distance of, for example, about 50 μm to 1 mm.

As a cooling member, for example, a metal plate 33 having a high thermal conductivity is disposed at a position facing the back surface of the secondary transferring belt 21 on the downstream side of the transferring and fixing roller 23 in the rotating direction of the secondary transferring belt 21. This metal plate 33 cools the secondary transferring belt 21 by depriving heat from the secondary transferring belt 21 after the transferring and fixing roller 23 performs transferring and fixing.

On the other hand, to a controller 40 which controls the overall image forming apparatus, a motor driver 41, a charge removal driver 43, a charging driver 44, an exposure driver 45, a developing driver 46, a transferring driver 47, a transferring driver 48, a transferring and heating driver 49, a charge removal driver 51, and a preheating driver 52 are connected.

The motor driver 41 drives a motor 42. This motor 42 rotationally drives the photoconductive drum 1, the primary transferring belt 11, and the secondary transferring belt 21, and also drives a mechanism for conveying the recording sheet 25, and the like.

The charge removal driver 43 drives the charge removal unit 2. The charging driver 44 applies a bias voltage for charging to the charging unit 3. The exposure driver 45 drives the exposure unit 4. The developing driver 46 applies a bias voltage for development to the developing roller 7. The transferring driver 47 applies a bias voltage for transferring to the first transferring roller 12. The transferring driver 48 applies a bias voltage for transferring to the second transferring roller 22. The transferring and heating driver 49 applies a bias voltage for transferring and heating to the transferring and heating roller 23. The charge removal driver 51 applies a bias voltage for charge removal to the second charge removal unit 31. The preheating driver 52 applies a voltage for operation to the infrared radiation plate 32.

Hereinafter, an operation will be described.

The electrical resistivity of the secondary transferring belt 21 formed of a porous elastic member is lower than that of a transferring belt formed of an elastic member having no pores to such an extent that the electric field for transferring supplied from the second transferring roller 22 does not leak to the surrounding area.

If the electrical resistivity of the secondary transferring belt 21 is small, a contact pressure between the primary transferring belt 11 and the secondary transferring belt 21 can be reduced. That is, even if the contact pressure between the primary transferring belt 11 and the secondary transferring belt 21 is reduced, the visible image on the primary transferring belt 11 can be reliably transferred to the secondary transferring belt 21. Therefore, the contact pressure between the primary transferring belt 11 and the secondary transferring belt 21 can be reduced.

As described above, since the contact pressure between the primary transferring belt 11 and the secondary transferring belt 21 can be reduced, the amount of heat transferred to the primary transferring belt 11 from the secondary transferring belt 21 can be reduced. As a result, unnecessary heat is not transferred to the photoconductive drum 1 and the visible image on the photoconductive drum 1, and therefore, favorable image formation can be achieved.

On the other hand, the toner 6 in the visible image immediately after the image is transferred to the secondary transferring belt 21 is charged, respectively. The charged toner 6 has a lot of voids containing air and has a larger volume as compared with a toner having no charge or low charge. When this toner 6 is heated, a visible image containing air bubbles is transferred and fixed to the recording sheet 25. That is, an image 26 having a low image quality is formed on the recording sheet 25.

Accordingly, the second charge removal unit 31 is disposed and the charge amount of the toner 6 in the visible image transferred to the secondary transferring belt 21 is reduced to such an extent that the reduction does not adversely affect the transferring by the transferring and fixing roller 23 at a stage before the transferring and fixing roller 23 performs transferring and fixing. In the toner 6 whose charge amount was reduced, a mutual repulsive force due to the charge of the toner 6 disappears, and aggregability and adhesiveness are increased to reduce the content of air. By reducing the content of air, a visible image containing air bubbles is not transferred or fixed to the recording sheet 25. As a result, an image 26 having a high image quality is formed on the recording sheet 25.

The primary transferring belt 11 is formed of polyimide and has a volume resistivity of 10⁺⁹ Ωcm and a surface resistivity of 10⁺¹⁰ Ωcm. The primary transferring roller 12 in which a conductive rubber elastic body is formed on a core metal presses the primary transferring belt 11 against the photoconductive drum 1. By this pressing, a transfer nip width of 1 mm is formed. The pressing pressure is 200 gf/cm². The charge potential of the photoconductive drum 1 is −700 V. The potential of the photoconductive drum 1 after light exposure is −50 V.

The charge amount of the toner 6 on a volume average basis is from −25 to −30 μC/g. The bias voltage for development is −350 V. The bias voltage for transferring is +1050 V. The secondary transferring belt 21 has a volume resistivity of 10⁺⁵ Ωcm and a surface resistivity of 10⁺⁸ Ωcm, and is formed of polyimide and is coated with a PFA layer as a surface layer. The secondary transferring roller 22 applies a pressure of 50 gf/cm² to a contact portion between the primary transferring belt 11 and the secondary transferring belt 21, whereby a transfer nip width of 0.5 mm or less is formed. The bias voltage for transferring is −2000 V. The roles of the backup roller 13 and the secondary transferring roller 22 may be opposite to each other. When the roles are opposite to each other, the bias voltage for transferring is +2000 V. In this secondary transferring region, the toner 6 is transferred to the secondary transferring belt 21. Incidentally, the optimal values of the respective potential conditions or toner charge amounts described here vary depending on the environmental temperature and humidity or the use history, and are not limited to the above-mentioned values.

When the volume resistivity of the secondary transferring belt 21 is equivalent to that of the primary transferring belt 11, in the above-mentioned secondary transferring region, a transfer nip of 1 mm and a transfer pressure of 200 gf/cm² are required. In this contact state, heat due to the transferring and fixing roller 23 or the infrared radiation plate 32 is transferred to the primary transferring belt 11, and there is a possibility that the primary transferring belt 11 is heated to a temperature not lower than the Tg of the toner 6, for example, 55° C. or higher, and the heat is transferred to the photoconductive drum 1 to adhere the transfer residual toner to the surface of the photoconductive drum 1, and moreover, when the heat is transferred to the toner 6 on the developing roller 7, the adhesion of the toner 6 in the developing unit 5 due to the stress of conveying or stirring the developer is accelerated. However, if weak contact as described above can be maintained, the amount of heat transferred to the primary transferring belt 11 from the secondary transferring belt 21 is small, and the region at a position in contact with the photoconductive drum 1 is not heated to such an extent that the region is maintained at a temperature not lower than the Tg of the toner 6. Therefore, the adhesion of the toner 6 on the photoconductive drum 1 or in the developing unit 5 can be prevented.

The data representing how the heat of the transferring and fixing roller 23 affect the photoconductive drum 1 when the linear pressure of the secondary transferring roller 22 and the backup roller 13 is changed is shown in the following table. The secondary transferring roller 22 is formed of aluminum and the backup roller 13 is formed of an iron round bar covered with ion conductive urethane rubber (layer thickness: 5 mm) and the urethane rubber portion has a volume resistivity in the thickness direction of 10⁺⁵ Ωcm. In order to enable the secondary transfer under each linear pressure, the volume resistivity of the secondary transferring belt 21 is changed. The locking of the developing unit 5 refers to a state in which the developing unit 5 cannot be driven because the toner particles in the developing unit 5 are melted by heat and adhered to a shaft portion of a stirring blade provided for stirring or conveying the developer in the developing unit 5.

TABLE

| Linear pressure | Volume resistivity | |
|---|---|---|
| of secondary | of secondary | |
| transfer [gf/cm²] | transferring belt | Locking of developing unit |
| 50 | 10⁺⁵ Ωcm | Locking does not occur when |
| | | printing is performed on |
| | | 100,000 sheets. |
| 100 | 10⁺⁷ Ωcm | Locking occurs when printing is |
| | | performed on 100,000 sheets. |
| 200 | 10⁺⁹ Ωcm | Locking occurs when printing is |
| | | performed on 20,000 sheets. |

When the linear pressure is decreased, the adhesion in the secondary transferring region is decreased, and therefore, the nip width is also decreased. Due to this, if the volume resistivity of the secondary transferring belt 21 is high, the transfer electric field is not sufficiently applied to the toner and the toner cannot be favorably transferred. However, the heat of the secondary transferring belt 21 is less transferred to the primary transferring belt 11, and therefore, the heat is not transferred to the toner 6 in the developing unit 5 and the locking of the developing unit 5 can be prevented. A preferred linear pressure of the secondary transferring member so as not to transfer heat to the developing unit 5 is from 10 to 100 gf/cm². If the linear pressure is too low, uniform contact cannot be obtained due to a trivial matter such as the subtle unevenness of the nip portion or vibration caused by driving the apparatus, resulting in uneven transfer, and therefore, it is not preferred. In order to obtain favorable transfer of the toner even at a low linear pressure for transferring, it is necessary to decrease the volume resistivity of the secondary transferring belt 21. If the volume resistivity is too low, the voltage for secondary transferring flows in the conveying direction and the toner is scattered, and therefore, it is necessary that the surface resistivity be higher than the volume resistivity, for example, about 10⁺⁸ Ωcm. A preferred volume resistivity of the secondary transferring belt 21 is from 10⁺⁴ Ωcm to 10⁺⁷ Ωcm.

Incidentally, in the above embodiment, the secondary transferring belt 21 is formed of a single layer of porous polyimide in which carbon black is incorporated by kneading. However, as shown in FIG. 3, the secondary transferring belt 21 may be formed such that the surface thereof on the side in contact with the primary transferring belt 11 is formed of a first porous polyimide layer 61 in which carbon black is incorporated by kneading, the surface thereof on the side in contact with the secondary transferring roller 22 is formed of a second porous polyimide layer 62 in which carbon black is incorporated by kneading, and at least one porous elastic layer 63 is sandwiched between the first porous polyimide layer 61 and the second porous polyimide layer 62. The porous elastic layer 63 is, for example, an open cell sponge. By interposing this porous elastic layer 63 therebetween, the adhesiveness at the contact portion with the primary transferring belt 11 becomes favorable.

As a material of the secondary transferring belt 21, other than polyimide, polyether sulfone, polyether etherketone, polysulfone, polyether amide, polyethylene naphthalate, polyphenylene sulfide, an aromatic polyamide, or the like can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrying member;
a developing unit which forms a visible image on the image carrying member by supplying a developer to the image carrying member;
a primary transferring member which is in contact with the image carrying member;
a first transferring unit which transfers the visible image formed on the image carrying member to the primary transferring member by applying an electric field to a contact portion between the image carrying member and the primary transferring member;
a secondary transferring member which is in contact with the primary transferring member;
a second transferring unit which transfers the visible image transferred to the primary transferring member to the secondary transferring member by applying a pressure from 10 to 100 gf/cm² and an electric field to a contact portion between the primary transferring member and the secondary transferring member; and
a transferring and fixing unit which transfers and fixes the visible image transferred to the secondary transferring member to a recording medium by heating and pressing.

2. The apparatus of claim 1, wherein the secondary transferring member is formed of a porous elastic member and the porous elastic member is formed polyimide.

3. The apparatus of claim 1, wherein the secondary transferring member is formed of a porous elastic member and the porous elastic member is formed polyimide in which carbon black is incorporated by kneading.

4. The apparatus of claim 1, wherein the secondary transferring member is formed such that the surface thereof on the side in contact with the primary transferring member is formed of a first porous polyimide layer, the surface thereof on the side in contact with the second transferring unit is formed of a second porous polyimide layer, and at least one porous elastic layer is sandwiched between the first porous polyimide layer and the second porous polyimide layer.

5. The apparatus of claim 1, wherein the secondary transferring member is formed such that the surface thereof on the side in contact with the primary transferring member is formed of a first porous polyimide layer in which carbon black is incorporated by kneading, the surface thereof on the side in contact with the second transferring unit is formed of a second porous polyimide layer in which carbon black is incorporated by kneading, and at least one porous elastic layer is sandwiched between the first porous polyimide layer and the second porous polyimide layer.

6. The apparatus of claim 5, wherein the porous elastic layer is an open cell sponge.

7. The apparatus of claim 1, further comprising:
a charge removal unit which removes the charge from the surface of the image carrying member;
a charging unit which charges the surface of the image carrying member from which the charge was removed by the charge removal unit; and
an exposure unit which exposes the surface of the image carrying member charged by the charging unit to light.

8. The apparatus of claim 7, wherein the developing unit includes a developing roller which charges the developer and supplies the charged developer to the surface of the image carrying member exposed to light by the exposure unit.

9. The apparatus of claim 7, further comprising:
a second charge removal unit which reduces the charge amount of the developer in the visible image transferred to the secondary transferring member at a stage before the transferring and fixing unit performs transferring and fixing;
a preheating member which preheats the developer whose charge amount was reduced by the second charge removal unit at a stage before the transferring and fixing unit performs transferring and fixing; and
a cooling member which cools the secondary transferring member after the transferring and fixing unit performs transferring and fixing.

10. The apparatus of claim 7, further comprising:
a developing driver which applies a bias voltage for development to the developing roller;
a first transferring driver which applies a bias voltage for transferring to the first transferring unit;
a second transferring driver which applies a bias voltage for transferring to the second transferring unit;
a charge removal driver which applies a bias voltage for charge removal to the second charge removal unit; and
a transferring and heating driver which applies a bias voltage for transferring and heating to the transferring and fixing unit.

11. An image forming apparatus comprising:
a photoconductive drum;
a developing unit which forms a visible image on the photoconductive drum by supplying a developer to the photoconductive drum;
a primary transferring belt which rotates in contact with the photoconductive drum;
a first transferring roller which transfers the visible image formed on the photoconductive drum to the primary transferring belt by applying an electric field to a contact portion between the photoconductive drum and the primary transferring belt;
a secondary transferring belt which rotates in contact with the primary transferring belt;
a second transferring roller which transfers the visible image transferred to the primary transferring belt to the secondary transferring belt by applying a pressure from 10 to 100 gf/cm² and an electric field to a contact portion between the primary transferring belt and the secondary transferring belt; and
a transferring and fixing roller which transfers and fixes the visible image transferred to the secondary transferring belt to a recording medium by heating and pressing.

12. The apparatus of claim 11, wherein the secondary transferring belt is formed of a porous elastic member and the porous elastic member is formed polyimide.

13. The apparatus of claim 11, wherein the secondary transferring belt is formed of a porous elastic member and the porous elastic member is formed polyimide in which carbon black is incorporated by kneading.

14. The apparatus of claim 11, wherein the secondary transferring belt is formed such that the surface thereof on the side in contact with the primary transferring belt is formed of a first porous polyimide layer, the surface thereof on the side in contact with the second transferring roller is formed of a second porous polyimide layer, and at least one porous elastic layer is sandwiched between the first porous polyimide layer and the second porous polyimide layer.

15. The apparatus of claim 11, wherein the primary transferring belt is formed such that the surface thereof on the side in contact with the photoconductive drum is formed of a first porous polyimide layer in which carbon black is incorporated by kneading, the surface thereof on the side in contact with the first transferring roller is formed of a second porous polyimide layer in which carbon black is incorporated by kneading, and at least one porous elastic layer is sandwiched between the first porous polyimide layer and the second porous polyimide layer.

16. The apparatus of claim 15, wherein the porous elastic layer is an open cell sponge.

17. The apparatus of claim 11, further comprising:
a charge removal unit which removes the charge from the surface of the photoconductive drum;
a charging unit which charges the surface of the photoconductive drum from which the charge was removed by the charge removal unit; and
an exposure unit which exposes the surface of the photoconductive drum charged by the charging unit to light.

18. The apparatus of claim 17, wherein the developing unit includes a developing roller which charges the developer by applying a charge thereto and supplies the charged developer to the surface of the photoconductive drum exposed to light by the exposure unit.

19. The apparatus of claim 17, further comprising:
a second charge removal unit which reduces the charge amount of the developer in the visible image transferred to the secondary transferring belt at a stage before the transferring and fixing roller performs heating and pressing;
a preheating member which preheats the developer whose charge amount was reduced by the second charge removal unit at a stage before the transferring and fixing roller performs heating and pressing; and
a cooling member which cools the secondary transferring belt after the transferring and fixing roller performs heating and pressing.

20. The apparatus of claim 19, further comprising:
a developing driver which applies a bias voltage for development to the developing roller;
a first transferring driver which applies a bias voltage for transferring to the first transferring roller;
a second transferring driver which applies a bias voltage for transferring to the second transferring roller;
a charge removal driver which applies a bias voltage for charge removal to the second charge removal unit; and
a transferring and heating driver which applies a bias voltage for transferring and heating to the transferring and fixing roller.
